(19) United States
(12) Patent Application Publication
(10) Pub. No.: US 2007/0108317 A1
(43) Pub. Date: May 17, 2007

(54) Fuel injection device, in particular for an internal combustion engine with direct fuel injection, and method for producing it non-provisional, utility

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/579,849

(22) PCT Filed: Sep. 8, 2004
(86) PCT No.: PCT/DE04/01997

§ 371 Date: May 17, 2006

(30) Foreign Application Priority Data
Nov. 24, 2003 (DE) 103 54 878.5

(51) Int. Cl. F02M 61/00

(52) U.S. Cl. 239/533.12; 239/533.2; 239/88

(57) ABSTRACT

A fuel injection device includes at least two valve elements, disposed in a housing and coaxial with one another, with at least one fuel outlet opening associated with each valve element. On the outer valve element, radially outward from the at least one fuel outlet opening associated with it, there is a first sealing edge which cooperates with a valve seat on the housing and can separate the at least one fuel outlet opening from a high-pressure connection. An additional sealing edge is provided on the outer valve element, between the at least one fuel outlet opening associated with it and the inner valve element.

### PRIOR ART

The invention relates first to a fuel injection device, in particular for an internal combustion engine with direct fuel injection, having a housing and at least two valve elements, located in the housing and coaxial to one another, to each of which at least one fuel outlet opening is assigned, and on the outer valve element, radially outward from the at least one fuel outlet opening assigned to it, there is a first sealing region, which cooperates with a valve seat on the housing and which can separate the at least one fuel outlet opening from a high-pressure connection.

A fuel injection device of the type defined above is known from German Patent Disclosure DE 101 22 241 A1. It has a housing with an outer valve element, in which an inner valve element is guided. Associated with each valve element is a series of fuel outlet openings. Both valve elements are stroke-controlled. This means that they each have a control face which acts in the closing direction and defines a control chamber. In the region of the fuel outlet openings, the valve elements each have pressure faces, which act in the opening direction and define pressure chambers, where at least at some times a high fluid pressure also prevails. The pressure faces and control faces are adapted such that whenever a high pressure prevails in the control chambers, both valve elements are closed. By means of briefly lowering the pressure in the control chamber, the forces operative in the closing direction can be reduced, which leads to an opening of one or both valve elements.

The use of two valve elements, each of which is assigned one fuel outlet opening, allows furnishing a small or large total outlet cross section, depending on the quantity of fuel to be injected. This in turn makes it possible to inject even comparatively small fuel quantities at high injection pressure, so that in these cases, good atomization of the fuel is attained. At the same time, high fuel quantities can be injected without requiring very long injection times to do so.

The object of the present invention is to refine a fuel injection device of the type defined at the outset such that it has as long a service life as possible, and the engine driven with it has good emissions performance.

This object is attained, in a fuel injection device of the type defined at the outset, in that on the outer valve element, between the at least one fuel outlet opening assigned to it and the inner valve element, there is an additional sealing region.

### ADVANTAGES OF THE INVENTION

The fuel injection device of the invention has a markedly longer service life than conventional fuel injection devices. The reason for this is that the additional sealing region largely prevents HC from the combustion chamber of the internal combustion engine from penetrating the device via the fuel outlet openings associated with the outer valve element and getting into the guide gap between the two valve elements, where it would cause changes in the surface properties and lead to deposits and finally to increased wear.

A further advantage is that the emissions performance of an internal combustion engine that is equipped with fuel injection devices of the invention is very good. The reason for this is the fact that because of the additional sealing region, fuel is prevented from passing through the guide gap between the two valve elements and, with the valve elements otherwise closed, reaching the combustion chamber from the at least one fuel outlet opening associated with the outer valve element.

Advantageous refinements of the invention are defined by the dependent claims.

First, it is proposed that the additional sealing region, immediately after the manufacture of the device, with the outer valve element closed, has a slight spacing, preferably approximately 1 to 2 μm, from a valve seat associated with it. As a result, the production costs of the fuel injection device of the invention are kept low, since producing the sealing region and the valve seat associated with it does not require especially high precision. Instead, the optimal sealing action of the sealing region is achieved only in the course of the initial time in operation of the fuel injection device, namely because of the normal initial deformation or the normal initial wear at the first sealing region and at the valve seat on the housing associated with it.

A chronological pressure profile upon the injection of fuel that is favorable for the emissions performance is attained if the first sealing region is embodied on the edge of a groove extending around the outer valve element.

In a refinement pointing in the same direction, an encompassing shallow groove extends from the encompassing groove approximately into the additional sealing region on the outer valve element.

Alternatively, it is possible that a plurality of grooves are present, distributed over the circumference and all extending in the axial direction approximately from the first groove mentioned approximately into the additional sealing region.

It is also possible that the additional sealing region is embodied on the edge of an encompassing narrow, deep groove, which is located toward the first sealing region. As a result, the so-called “seat throttling” is also varied and optimized.

Preferably, the additional sealing region is embodied on an annular protuberance projecting from the outer valve element. This leads to good sealing action and economical production.

The advantages of the invention are especially striking whenever the fuel injection device is embodied such that a guide gap present between the two valve elements communicates with a chamber that communicates with the high-pressure connection. Such a chamber may for instance be a hydraulic control chamber, of the kind that is present in stroke-controlled valve elements.

The invention also relates to a method for producing a fuel injection device of the type defined above. To keep production costs low, it proposed that the outer valve element is fabricated such that the additional sealing region, with the outer valve element closed, initially has a slight spacing, preferably of approximately 1 to 2 μm, from a valve seat associated with it; and that then by repeated actuation of the outer valve element, the first sealing region and/or the valve seat associated with it is deformed such that the spacing between it and the valve seat associated with it becomes less or tends toward zero.

### DRAWING

Especially preferred exemplary embodiments of the present invention will be described in further detail below in conjunction with the accompanying drawing. In the drawing:

FIG. 1 is a section through a region of a fuel injection device;

FIG. 2 is a detail II of FIG. 1;

FIG. 3 is a view similar to FIG. 2 of an alternative embodiment; and

FIG. 4 is a view similar to FIG. 2 of a further-modified embodiment.

### DESCRIPTION OF THE EXEMPLARY EMBODIMENTS

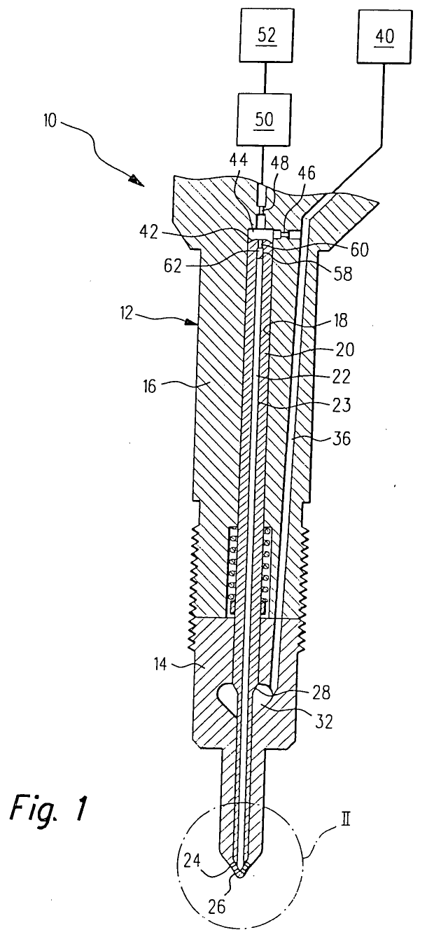

In FIG. 1, a fuel injection device is identified overall by reference numeral 10. It includes a housing 12, of which in FIG. 1 only a nozzle body 14 and a central piece 16 are shown. The nozzle body 14 is clamped relative to the central piece 16 via a straining screw, not shown.

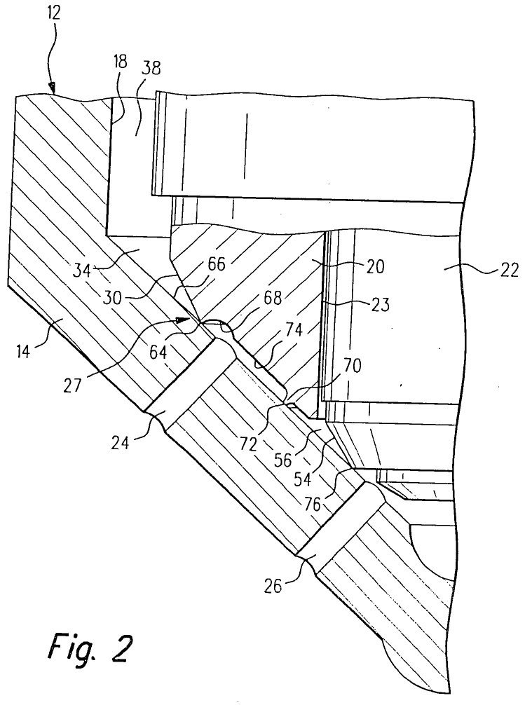

In the housing 12, there is a recess 18, into which an outer valve element 20 and an inner valve element 22 are inserted. Between them, there is a guide gap 23 (see FIG. 2). As will be discussed hereinafter in greater detail, a series of fuel outlet conduits 24 is associated with the outer valve element 20, while a series of fuel outlet conduits 26 is associated with the inner valve element 22.

The outer valve element 20 has a conical end region 27. On it, there are pressure faces 28 and 30 (see FIG. 2), acting in the opening direction, which define pressure chambers 32 and 34, which communicate constantly, via a high-pressure conduit 36 and an annular chamber 38, which is located between the recess 18 and the outer valve element 20, with a high-pressure connection 40. The high-pressure connection 40 of the fuel injection device 10 is connected to a fuel collection line (“rail”), not shown, in which fuel, such as gasoline or diesel, is stored at very high pressure.

On the end of the outer valve element 20 facing away from the fuel outlet conduits 24, this valve element has a control face 42, which acts in the closing direction and defines a control chamber 44. The control chamber communicates constantly with the high-pressure conduit 36 via an inflow throttle restriction 46. An outflow throttle restriction 48 leads from the control chamber 44, via a switching valve 50, to a low-pressure connection 52. The low-pressure connection is connected to a return line, not shown, which for instance returns to a fuel tank.

The inner valve element 22 also has a conical end region 53, with a pressure face 54 (FIG. 2) that acts in the opening direction and defines a pressure chamber 56, but the pressure chamber communicates with the high-pressure connection 40 via the annular chamber 38 and the high-pressure conduit 36 only when the outer valve element 20 is open. On the end facing away from the fuel outlet conduits 26, the inner valve element 22 also has a control face 58, which acts in the closing direction and defines a control chamber 62, which is located in the outer valve element 20 and communicates with the control chamber 44 via a conduit 60.

As can be seen from FIG. 2, the outer valve element 20 has a first sealing region, in the form of a first sealing edge 64, which cooperates with a diametrically opposed valve seat face 66 on the housing. The sealing edge 64 is embodied on the radially outer edge of a groove 68 extending around the outer valve element 20. The radially inner edge of this groove is located approximately facing the middle of the fuel outlet conduits 24. Radially obliquely inward from the groove 68, or from the fuel outlet conduits 24, there is an annular protuberance 70 extending all the way around on the conical end region 27 of the outer valve element 20; its projecting edge forms an additional sealing region, in the form of a second sealing edge 72. This sealing edge cooperates with a radially obliquely inward-located region of the valve seat face 66 of the housing. An encompassing shallow groove 74 extends from the groove 68 to the annular protuberance 70.

On the inner valve element 22 as well, there is a sealing edge 76. It defines the pressure face 54 radially obliquely inward and cooperates with a likewise radially obliquely inward-located region of the valve seat face 66. When the inner valve element 22 is closed, the series of fuel outlet conduits 26, which are associated with the inner valve element 22, is located radially obliquely inward from the sealing edge 76.

The fuel injection device 10 shown in FIGS. 1 and 2 is operated as follows:

Via the high-pressure connection 40 and the high-pressure conduit 36 as well as the annular chamber 38, the high fuel pressure which also prevails in the fuel rail is applied constantly to the pressure faces 28 and 30 of the outer valve element 20. It is assumed initially that the switching valve 50 is closed. In that case, this high fuel pressure also prevails in both the control chamber 44 and the control chamber 62. Since the control face 42 of the outer valve element 20 is larger than the total area of the two pressure faces 28 and 30, there is a resultant force acting in the closing direction, by which the sealing edge 64 and the second sealing edge 72 are both pressed against the valve seat face 66. The communication from the annular chamber 38 or the pressure chamber 34 to the series of fuel outlet conduits 24 is thus interrupted. The pressure chamber 56, which is defined by the pressure face 54 of the inner valve element 22, is also separated from the high fuel pressure that prevails in the annular chamber 38.

For injecting a comparatively small quantity of fuel, the switching valve 50 is briefly opened. As a result, fuel can flow out of the control chamber 44 via the outflow throttle restriction 48 to the low-pressure connection 52. Since the fuel flows out faster than it can flow in through the inflow throttle restriction 46, the pressure in the control chamber 44 drops, as does the corresponding force acting on the control face 42 in the closing direction. As a consequence, there is a resultant force acting overall in the opening direction (after all, the high fuel pressure continues to act on the pressure faces 28 and 30), so that the outer valve element 20 opens, and the sealing edges 64 and 72 lift from the opposite valve seat face 66.

As a result, the annular chamber 38 or the pressure chamber 34 is made to communicate with the series of fuel outlet conduits 24, so that fuel exits at high pressure through the fuel outlet conduits 24.

With the outer valve element 20 open, a correspondingly high fuel pressure also prevails in the pressure chamber 56, and this leads to a force acting in the opening direction at the pressure face 54 of the inner valve element 22. However, since the switching valve 50 is opened only briefly, and since the conduit 60 that connects the control chamber 44 of the outer valve element 20 with the control chamber 62 of the inner valve element 22 is embodied as a flow throttle, the lowering of pressure in the control chamber 22 has only a delayed and limited effect on the control chamber 62. In any case, the reduction in pressure in the control chamber 62 is only so slight that the force acting in the closing direction on the control face 58 is greater than the force acting in the opening direction of the pressure face 54. The inner valve element 22 therefore remains closed. Fuel can accordingly not exit through the fuel outlet conduits 26 associated with the inner valve element 22.

If a greater fuel quantity is to be injected, then the switching valve 50 is opened for a comparatively longer time. As a consequence, there is also a pronounced pressure drop in the control chamber 62, which is defined by the control face 58 on the inner valve element 22. This pressure drop is so pronounced that the force acting in the opening direction on the pressure face 54 of the inner valve element 22 now predominates, and the inner valve element 22 opens. Fuel can now exit from the fuel outlet conduits 26 as well. The injection is terminated by closing the switching valve 50.

Above all upon termination of an injection, the additional second sealing edge 72, which is present on the outer valve element 20, has particular significance: That is, it prevents fuel from emerging from the fuel outlet conduits 24 whenever the first sealing edge 64 is already resting on the valve seat face 66. In this respect the following should be noted:

In the control chamber 62, particularly with the valve elements 20 and 22 closed, a comparatively high fuel pressure prevails. It is true that the inner valve element 22 is guided in fluid-tight fashion in the outer valve element 20, but such a fluid-tight guidance cannot completely prevent fuel from passing through. To assure an ease of motion of the inner valve element 22, there must in fact be the guide gap 23 between the inner valve element 22 and the outer valve element 20. Via this guide gap 23, a slight quantity of fuel can flow out of the control chamber 62 into the pressure chamber 56.

If the additional sealing edge 72 were not present, this “leak fuel” could pass unhindered out of the pressure chamber 56 to reach the fuel outlet conduits 24 and could emerge through them into the combustion chamber of the engine. That would worsen the emissions performance of the engine. By means of the additional sealing edge 72, the communication between the pressure chamber 56 and the fuel outlet conduits 24 when the outer valve element 20 is closed is interrupted. Leak fuel passing through the guide gap 78 can accordingly no longer reach the fuel outlet conduits 24.

The additional sealing edge 72 on the outer valve element 20 has still another effect as well: In combustion, HC is created in the combustion chamber of the engine. The HC can reach the interior of the fuel injection device 10 via the fuel outlet conduits 24 and 26. The second sealing edge 72 reliably prevents HC from getting into the guide gap 23 between the inner valve element 22 and the outer valve element 20. Correspondingly increased wear in the region of the guide gap 78 is thus reliably avoided.

The outer valve element 20 of the fuel injection device 10 shown in FIGS. 1 and 2 thus has a “double seat”, which can typically be produced only at great effort and expense. This effort and expense is reduced markedly, however, in the fuel injection device shown: The additional sealing edge 72 is in fact produced with a defined minimum size. This means nothing else than that initially, in a new and as yet unused fuel injection device, with the valve element 20 closed, it has a spacing from the opposed valve seat face 66. In the present exemplary embodiment, this spacing amounts to approximately 1 to 2 μm.

When the fuel injection device is put into operation, a certain initial wear or initial deformation necessarily occurs at the first sealing edge 64 and the opposed valve seat face 66. As a result, the gap that initially exists between the additional sealing edge 72 and the opposed valve seat face 66, when the outer valve element 20 is closed, decreases in size, until the additional sealing edge 72, when the valve element 20 is closed, also rests on the opposed valve seat face 66 and thus assures secure sealing.

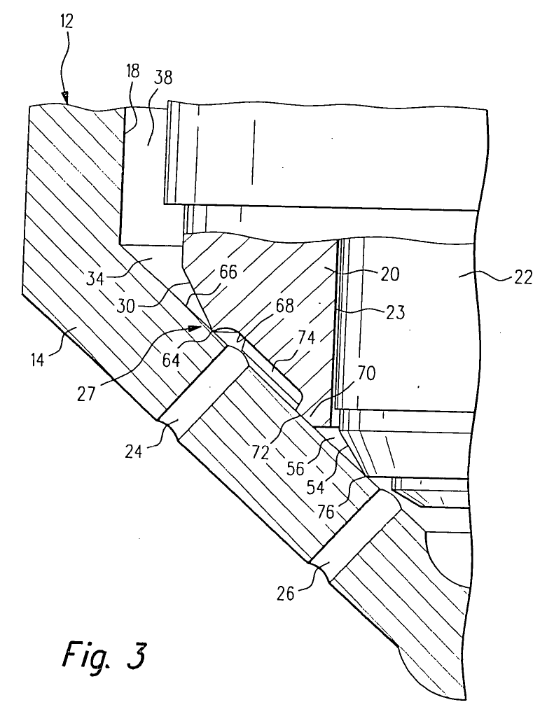

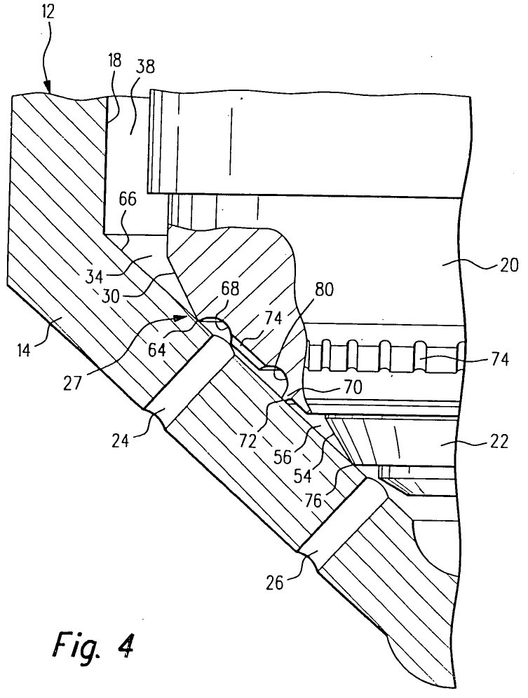

Alternative embodiments of fuel injection devices 10 are shown in FIGS. 3 and 4. Elements and regions that have equivalent functions to elements and regions of the fuel injection device shown in FIGS. 1 and 2 have the same reference numerals. They are not explained again in detail. The distinctions essentially pertain to the design of the conical end region 27 of the outer valve element 20 between the groove 68 and the annular protuberance 70:

In the fuel injection device 10 shown in FIG. 3, instead of a single encompassing shallow groove, there is a plurality of grooves 74, distributed over the circumference and all extending in the axial direction. Moreover, in the fuel injection device 10 shown in FIG. 3, the annular protuberance 70 has a greater width. In FIG. 4, in turn, in addition to the grooves 74, there is an encompassing groove 80, which is radially obliquely outward from the annular protuberance 70 and whose cross section, like that of the groove 68, is approximately semicircular.

1-9. (canceled)

10. In a fuel injection device, for an internal combustion engine with direct fuel injection, having a housing and at least two valve elements, located in the housing and coaxial to one another, to each of which at least one fuel outlet opening is assigned, and on the outer valve element, radially outward from the at least one fuel outlet opening assigned to it, there is a first sealing region, which cooperates with a valve seat on the housing and which can separate the at least one fuel outlet opening from a high-pressure connection, the improvement comprising an additional sealing region on the outer valve element, between the at least one fuel outlet opening assigned to it and the inner valve element.

11. The fuel injection device in accordance with claim 10, wherein the additional sealing region, immediately after the manufacture of the device, with the outer valve element closed, has a slight spacing, preferably approximately 1 to 2 μm, from the valve seat associated with it.

12. The fuel injection device in accordance with claim 11, wherein the first sealing region is embodied on the edge of a groove extending around the outer valve element.

13. The fuel injection device in accordance with claim 10, wherein the first sealing region is embodied on the edge of a groove extending around the outer valve element and further comprising an encompassing shallow groove extending approximately from the encompassing groove approximately into the additional sealing region on the outer valve element.

14. The fuel injection device in accordance with claim 11, wherein the first sealing region is embodied on the edge of a groove extending around the outer valve element and further comprising an encompassing shallow groove extending approximately from the encompassing groove approximately into the additional sealing region on the outer valve element.

15. The fuel injection device in accordance with claim 10, wherein the first sealing region is embodied on the edge of a groove extending around the outer valve element and further comprising a plurality of grooves distributed over the circumference and all extending in the axial direction approximately from the encompassing groove approximately into the additional sealing region.

16. The fuel injection device in accordance with claim 11, wherein the first sealing region is embodied on the edge of a groove extending around the outer valve element and further comprising a plurality of grooves distributed over the circumference and all extending in the axial direction approximately from the encompassing groove approximately into the additional sealing region.

17. The fuel injection device in accordance with claim 10, wherein the additional sealing region is embodied on the edge of an encompassing narrow, deep groove, which groove is located in the direction toward the first sealing region.

18. The fuel injection device in accordance with claim 11, wherein the additional sealing region is embodied on the edge of an encompassing narrow, deep groove, which groove is located in the direction toward the first sealing region.

19. The fuel injection device in accordance with claim 12, wherein the additional sealing region is embodied on the edge of an encompassing narrow, deep groove, which groove is located in the direction toward the first sealing region.

20. The fuel injection device in accordance with claim 13, wherein the additional sealing region is embodied on the edge of an encompassing narrow, deep groove, which groove is located in the direction toward the first sealing region.

21. The fuel injection device in accordance with claim 15, wherein the additional sealing region is embodied on the edge of an encompassing narrow, deep groove, which groove is located in the direction toward the first sealing region.

22. The fuel injection device in accordance with claim 10, wherein the additional sealing region is embodied on an annular protuberance projecting from the outer valve element.

23. The fuel injection device in accordance with claim 11, wherein the additional sealing region is embodied on an annular protuberance projecting from the outer valve element.

24. The fuel injection device in accordance with claim 12, wherein the additional sealing region is embodied on an annular protuberance projecting from the outer valve element.

25. The fuel injection device in accordance with claim 10, further comprising a guide gap between the two valve elements, and wherein the guide gap communicates with a chamber that communicates at least from time to time with the high-pressure connection.

26. The fuel injection device in accordance with claim 1, further comprising a guide gap between the two valve elements, and wherein the guide gap communicates with a chamber that communicates at least from time to time with the high-pressure connection.

27. The fuel injection device in accordance with claim 12, further comprising a guide gap between the two valve elements, and wherein the guide gap communicates with a chamber that communicates at least from time to time with the high-pressure connection.

28. The fuel injection device in accordance with claim 17, further comprising a guide gap between the two valve elements, and wherein the guide gap communicates with a chamber that communicates at least from time to time with the high-pressure connection.

29. A method for producing a fuel injection device in accordance with claim 10, comprising the steps of fabricating the outer valve element such that the additional sealing region, with the outer valve element closed, initially has a slight spacing, preferably of approximately 1 to 2 μm, from a valve seat associated with it; and that then by repeated actuation of the outer valve element, the first sealing region and/or the valve seat associated with it is deformed such that the spacing between it and the valve seat associated with it becomes less or tends toward zero.
